(19) United States
(12) Patent Application Publication
(10) Pub. No.: US 2025/0005786 A1
(43) Pub. Date: Jan. 2, 2025

(54) Image Pick-Up System and Image Pick-Up Method

(71) Applicant: SHIMADZU CORPORATION, Kyoto-shi (JP)

(72) Inventors: Tomotaka NAGASHIMA, Kyoto-shi (JP); Yusuke TAGAWA, Kyoto-shi (JP); Kazuma TAKAHARA, Kyoto-shi (JP); Shinji IMAI, Kyoto-shi (JP); Seiya KURATA, Kyoto-shi (JP)

(21) Appl. No.: 18/691,356

(22) PCT Filed: Jul. 8, 2022
(86) PCT No.: PCT/JP2022/027111

§ 371 Date: Mar. 12, 2024

(30) Foreign Application Priority Data
Sep. 14, 2021 (JP) 2021-149115

(51) Int. Cl. G06T 7/73; G06T 7/11; G06T 7/50

(52) U.S. Cl. CPC G06T 7/73; G06T 7/11; G06T 7/50; G06T 2207/30204; G06T 2207/30244

(57) ABSTRACT

A camera that picks up an image of an object arranged in a real space and a controller are provided. The controller includes a setting unit that sets a target range in the real space, an obtaining unit that obtains a position and a posture of the camera, a determination unit that determines whether or not an object included in an image picked up by the camera is included in the target range based on the position and the posture of the camera, and an image processor that performs image processing on the image picked up by the camera, the image processing selected depending upon a result of determination by the determination unit.

### TECHNICAL FIELD

The present disclosure relates to an image pick-up system and an image pick-up method.

### BACKGROUND ART

A technology to recognize in real time, an object projected in an image picked up by a camera has conventionally been known. For example, a face recognition technology for recognizing a face of a person projected in an image has been known (see NPL 1 “Yoshio Iwai et al., ‘A Survey on Face Detection and Face Recognition,’ IPSJ SIG Technical Report. CVIM, [Computer Vision and Image Media] 149, May 13, 2005, pp. 343-368”).

NPL 1 discloses extraction of a feature value from information held by each pixel included in an image and correlation between pixels and recognition of a face of a person based on the feature value. NPL 1 describes generation of a recognition model for face recognition by learning of sample images.

### CITATION LIST

### Non Patent Literature

NPL 1: Yoshio Iwai et al., “A Survey on Face Detection and Face Recognition,” IPSJ SIG Technical Report. CVIM, [Computer Vision and Image Media] 149, May 13, 2005, pp. 343-368

### SUMMARY OF INVENTION

### Technical Problem

Each and every type of object, however, is present in a real space. Generation of an individual recognition model corresponding to each object in order to distinguish between an object to be shown and an object not to be shown among various types of objects included in a picked-up image leads to increase in cost.

The present invention was made to solve such a problem, and an object thereof is to distinguish between an object to be shown in a picked-up image and an object not to be shown in the picked-up image without generation of a recognition model in an image pick-up system to thereby suppress increase in cost.

### Solution to Problem

An image pick-up system in the present disclosure includes a first camera that picks up an image of an object arranged in a real space and a controller. The controller includes a setting unit, an obtaining unit, a determination unit, and an image processor. The setting unit sets a first range in the real space. The obtaining unit obtains a position and a posture of the first camera. The determination unit determines whether or not an object included in the image picked up by the first camera is included in the first range based on the position and the posture of the first camera. The image processor performs image processing on the image picked up by the first camera, the image processing selected depending upon a result of determination by the determination unit.

An image pick-up method according to the present disclosure is an image pick-up method of picking up, with a camera, an image of an object arranged in a real space. The image pick-up method according to the present disclosure includes setting a first range in the real space, obtaining a position and a posture of the camera, determining whether or not an object included in an image picked up by the camera is included in the first range based on the position and the posture of the camera, and performing image processing on the image picked up by the first camera, the image processing selected depending upon a result of determination in the determining.

### Advantageous Effects of Invention

In the image pick-up system according to the present disclosure, the setting unit sets the first range and the determination unit determines whether or not the object included in the picked-up image is an object not included in the first range. The image processor performs image processing on the picked-up image, the image processing selected depending upon the result of determination by the determination unit. Specifically, the image pick-up system generates an image that shows an object arranged in the first range and an object not arranged in the first range as being distinguished from each other. According to such a configuration, the image pick-up system can distinguish between the object to be shown in the image and the object not to be shown in the image, without generation of a recognition model, and can achieve suppression of increase in cost.

### BRIEF DESCRIPTION OF DRAWINGS

FIG. 1 is a block diagram showing a configuration of an image pick-up system in the present embodiment.

FIG. 2 is a diagram for illustrating image pick-up by the image pick-up system in the present embodiment.

FIG. 3 is a diagram showing an image at the time of image pick-up of a target range by a camera from a position Ps1.

FIG. 4 is a diagram showing an image at the time of image pick-up of the target range by the camera from a position Ps2.

FIG. 5 is a flowchart for the image pick-up system in the present embodiment to perform mask processing.

FIG. 6 is a diagram showing an image resulting from mask processing of an image shown in FIG. 5.

FIG. 7 is a diagram showing an image resulting from mask processing of an image shown in FIG. 6.

FIG. 8 is a diagram showing a flowchart for setting the target range.

FIG. 9 is a diagram showing relation of a position and a posture of the camera with the target range.

FIG. 10 is a diagram showing an image which is combination of a result of detection by a distance sensor and an image from the camera.

FIG. 11 is a diagram for illustrating setting of the target range based on plane detection.

FIG. 12 is a diagram showing a flowchart of a method of setting a target range based on plane detection.

FIG. 13 is a diagram for illustrating a method of setting a target range with the use of a marker.

FIG. 14 is a diagram for illustrating relation between an amount of change of an image and an amount of movement of the camera.

FIG. 15 is a diagram showing storage of 3D data representing a real space in a storage.

FIG. 16 is a block diagram showing a configuration of an image pick-up system in a fifth modification.

FIG. 17 is a diagram for illustrating image pick-up by the image pick-up system in the fifth modification.

### DESCRIPTION OF EMBODIMENTS

### Embodiment

An embodiment of the present invention will be described in detail below with reference to the drawings. The same or corresponding elements in the drawings have the same reference characters allotted and description thereof will not be repeated.

### <Overall Configuration of Image Pick-Up System>

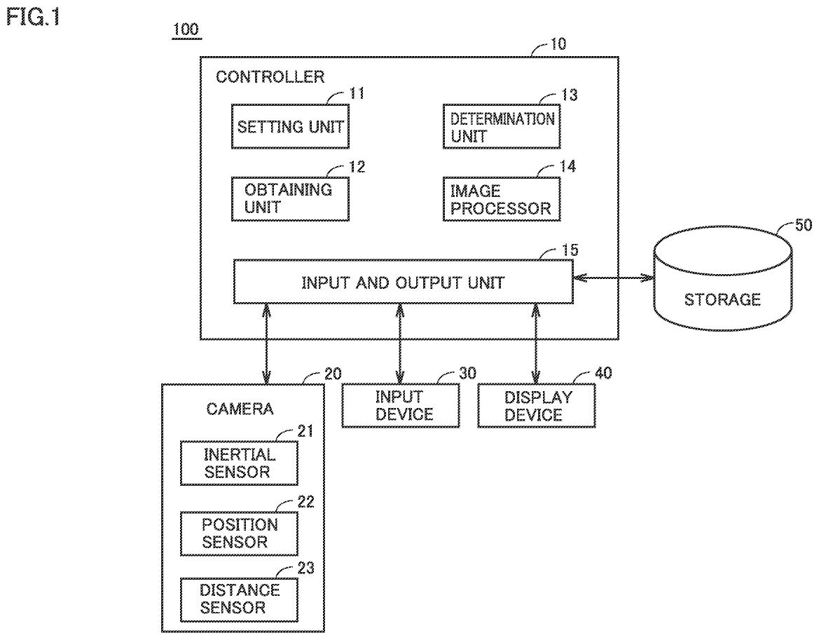

FIG. 1 is a block diagram showing a configuration of an image pick-up system 100 in the present embodiment. Image pick-up system 100 in the present embodiment is a system that includes a camera 20 and processes an image picked up by camera 20. Image pick-up system 100 is a system that picks up images of various objects arranged in a real space as moving images and shows and records an object to be shown and an object not to be shown among objects included in the moving images, as being distinguished from each other.

Image pick-up system 100 includes a controller 10, an input device 30, a display device 40, and a storage 50, in addition to camera 20. In the present embodiment, image pick-up system 100 is implemented, for example, as one smartphone including controller 10, camera 20, input device 30, display device 40, and storage 50.

At least one of elements included in image pick-up system 100 may be provided as separate equipment. For example, image pick-up system 100 may be configured to include, in addition to a general-purpose computer including controller 10, input device 30, display device 40, and storage 50, camera 20 separate from the general-purpose computer. For example, camera 20 may be a general video camera or the like.

Controller 10 includes a setting unit 11, an obtaining unit 12, a determination unit 13, an image processor 14, and an input and output unit 15. Setting unit 11 sets a target range in the real space in accordance with selection by a user. Obtaining unit 12 obtains a position (a three-dimensional coordinate in the real space) and a posture (pitch, roll, and heading) of camera 20. Determination unit 13 determines whether or not an object included in an image picked up by camera 20 is included in the target range, based on the position and the posture of camera 20. Image processor 14 performs mask processing on an object determined as not being included in the target range by determination unit 13. Input and output unit 15 transmits and receives a signal to and from each of camera 20, input device 30, display device 40, and storage 50.

Controller 10 includes a central processing unit (CPU) and a random access memory (RAM) as a hardware configuration. The CPU executes or refers to various programs and data read into the RAM. In one aspect, the CPU may be substituted with an embedded CPU, a field-programmable gate array (FPGA), or combination thereof.

A program executed by the CPU and data referred to by the CPU are stored in the RAM. In one aspect, the RAM may be implemented by a dynamic random access memory (DRAM) or a static random access memory (SRAM).

Camera 20 picks up an image of an object arranged in the real space. Camera 20 in the present embodiment includes an inertial sensor 21, a position sensor 22, and a distance sensor 23. Camera 20 corresponds to the “first camera” in the present disclosure.

Inertial sensor 21 is typically implemented by an inertial measurement unit (IMU), which is, for example, combination of an acceleration sensor and a gyro sensor or combination thereof with a geomagnetic sensor.

Position sensor 22 is a sensor that specifies a position of camera 20. Position sensor 22 is implemented, for example, by a global positioning system (GPS) receiver. In order to more precisely specify the position of camera 20, position sensor 22 may be combined with an infrared sensor, an ultrasonic sensor, or the like.

Distance sensor 23 detects a distance between an object arranged in the real space and camera 20. For example, distance sensor 23 detects a distance from an object with the use of time-of-flight (TOF) light. Alternatively, distance sensor 23 may be implemented by laser imaging detection and ranging (LIDAR), a stereo camera capable of measuring a distance, or a depth camera. Distance sensor 23 may be provided separately from camera 20.

Input device 30 is typically implemented by a keyboard, a mouse, or the like. Display device 40 is typically implemented by a liquid crystal display or an organic electro luminescence (EL) display. Input device 30 and display device 40 may be provided as being integrated as a touch screen. Input device 30 accepts input of information on a target range Rg1 from a user.

Storage 50 is typically implemented by a read only memory (ROM). In other words, storage 50 is a non-volatile memory, and a program to be executed by the CPU or the like is stored therein. The CPU executes a program read from the ROM to the RAM. In one aspect, the ROM may be implemented by an erasable programmable read only memory (EPROM), an electrically erasable programmable read-only memory (EEPROM), or a flash memory. Storage 50 may include a hard disk drive (HDD) or a flash solid state drive (SSD).

### <Specific Example of Image Pick-Up System>

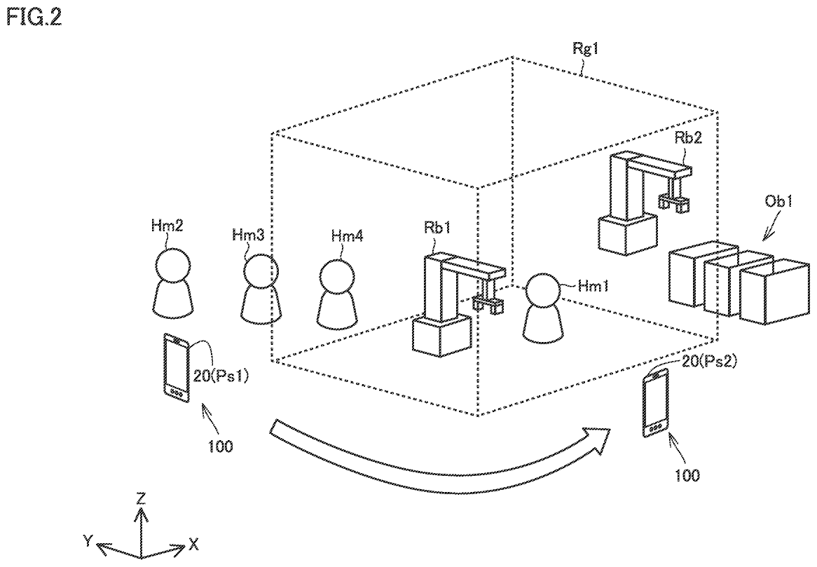

FIG. 2 is a diagram for illustrating image pick-up by image pick-up system 100 in the present embodiment. As described above, image pick-up system 100 picks up images of various objects arranged in the real space as moving images, and distinguishes between an object arranged in a range other than target range Rg1 and an object arranged in target range Rg1 in the moving images.

In image pick-up or distribution of moving pictures, image pick-up system 100 in the present embodiment can be used for mask processing, for example, only on an object arranged in a region where image pick-up is not permitted among objects projected in the obtained moving pictures. Image pick-up system 100 in the present embodiment is applied to erasure of a portion relating to confidential information included in a picked-up image, in image pick-up of an apparatus or work contents in a factory or a laboratory for recording as moving images or transmission thereof to other equipment.

FIG. 2 shows an example in which an image of a human operator Hm1 and a robot Rb1 is to be picked up in the inside of a factory. FIG. 2 shows a smartphone representing one example of image pick-up system 100 in the present embodiment, target range Rg1, and other various types of objects.

Target range Rg1 in FIG. 2 is in a shape of a parallelepiped. So long as target range Rg1 includes a spatial region, it may be in any shape without being limited to the shape of the parallelepiped. For example, target range Rg1 may be in a polyhedral, spherical, or columnar shape. Information on target range Rg1 is stored in storage 50. The information on target range Rg1 is information on a region occupied by target range Rg1, and includes, for example, a coordinate indicating the region occupied by target range Rg1.

In the description below, a vertical direction is defined as a Z-axis direction, and a surface perpendicular to the Z-axis direction is defined as an X axis and a Y axis. An X-axis direction and a Y-axis direction are directions along sides of target range Rg1 in the shape of the parallelepiped. A positive direction and a negative direction along the Z axis in each figure may be referred to as an upper side and a lower side, respectively. Target range Rg1 corresponds to the “first range” in the present disclosure.

As shown in FIG. 2, in target range Rg1, human operator Hm1 and robot Rb1 that are image pick-up targets are arranged. On a side of the positive direction along the X axis of target range Rg1, a robot Rb2 and an object Ob1 that are not image pick-up targets are arranged. In FIG. 2, object Ob1 is three boxes. Object Ob1 may be, for example, a tool such as a table, a chair, or industrial equipment, and should only be an object having a shape. Furthermore, on the side of the positive direction along the Y axis of target range Rg1, human operators Hm2, Hm3, and Hm4 that are not image pick-up targets are arranged.

The smartphone representing one example of image pick-up system 100 in the present embodiment shown in FIG. 2 includes camera 20. A picture taker (not shown) with the smartphone starts image pick-up such that human operator Hm1 and robot Rb1 which are image pick-up targets are included in an angle of view of camera 20. The picture taker with the smartphone takes moving images with camera 20 while moving from a position Ps1 to a position Ps2. Position Ps1 is a position on a side of the negative direction along the X axis of target range Rg1. Position Ps2 is a position on the side of the negative direction along the Y axis of target range Rg1.

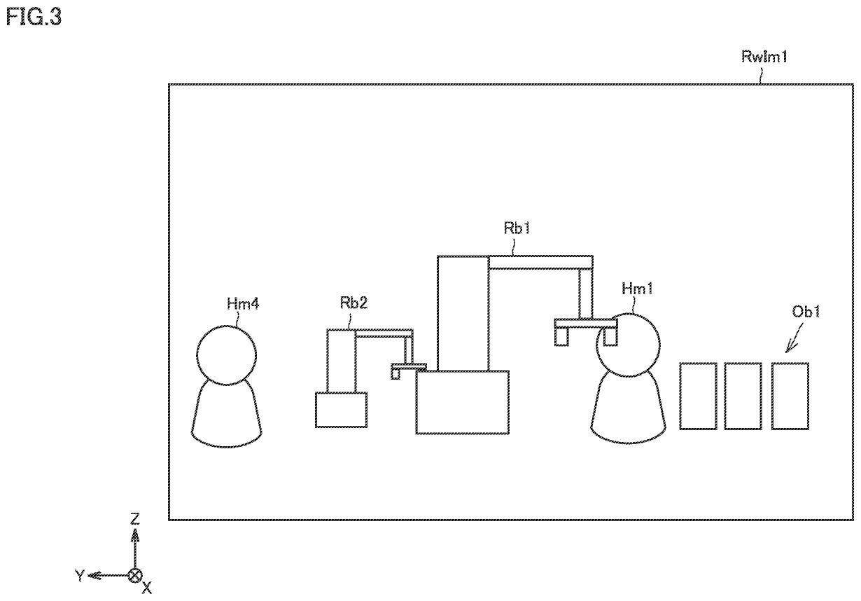

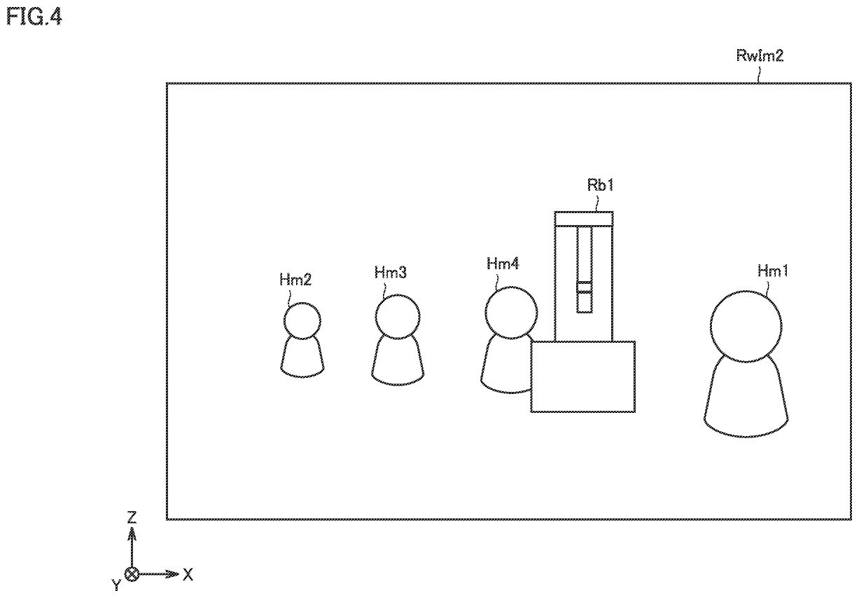

A raw image picked up by camera 20 will be described below with reference to FIGS. 3 and 4. Each of images shown in FIGS. 3 and 4 is a raw image corresponding to one frame of a plurality of frames included in the picked-up moving images.

FIG. 3 is a diagram showing an image RwIm1 at the time of image pick-up of target range Rg1 by camera 20 from position Ps1. As shown in FIG. 3, image RwIm1 at the time of image pick-up from position Ps1 includes robot Rb2, object Ob1, and human operator Hm4 which are not image pick-up targets, in addition to robot Rb1 and human operator Hm1 which are image pick-up targets.

FIG. 4 is a diagram showing an image RwIm2 at the time of image pick-up of target range Rg1 by camera 20 from position Ps2. As shown in FIG. 4, image RwIm2 at the time of image pick-up from position Ps2 includes human operators Hm2 to Hm4 which are not image pick-up targets, in addition to robot Rb1 and human operator Hm1 which are image pick-up targets.

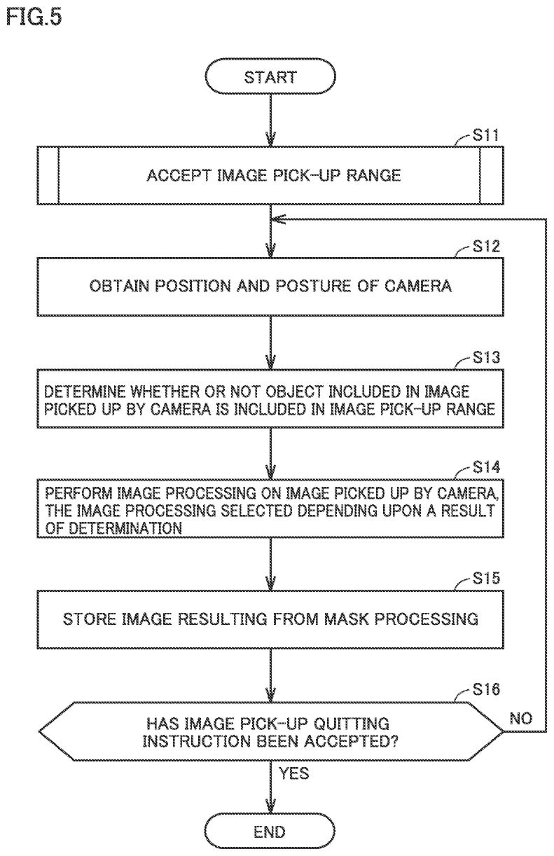

In addition to an object which is an image pick-up target, an object which is not an image pick-up target is thus shown and recorded in a raw image picked up by camera 20. When an object which is not an image pick-up target includes confidential information, use of the image picked up by camera 20 may be disallowed. Image pick-up system 100 then performs mask processing on the raw images shown in FIGS. 3 and 4 in a procedure shown in FIG. 5. Image pick-up system 100 performs the mask processing not only on the images shown in FIGS. 3 and 4 but also on each of a plurality of frames included in the moving images picked up by camera 20.

### <Flowchart of Mask Processing>

FIG. 5 is a flowchart of the mask processing in image pick-up system 100 in the present embodiment. The flowchart in FIG. 5 is performed in controller 10 when a prescribed start condition is satisfied and a program stored in the ROM is called. Alternatively, at least one and all of steps in the flowchart may be performed by dedicated hardware circuitry.

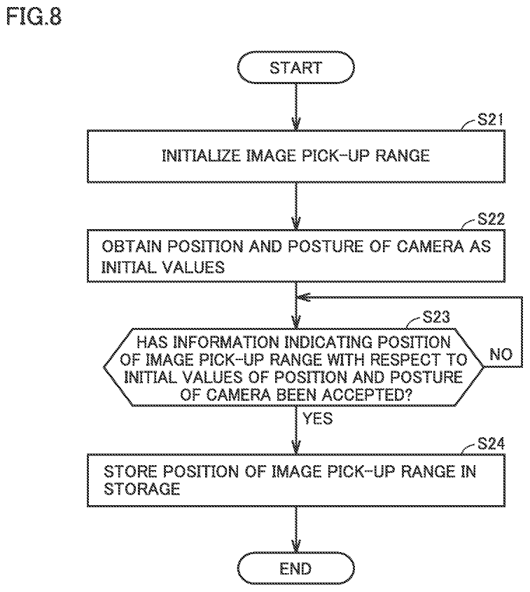

Controller 10 sets target range Rg1 in accordance with an input from a user (step S11). A detailed method of setting target range Rg1 in step S11 will be described later with reference to FIG. 8. Controller 10 obtains a position and a posture of camera 20 (step S12). In the present embodiment, obtaining unit 12 obtains the position and the posture of camera 20 based on detection values from inertial sensor 21 and position sensor 22 included in camera 20.

The position of camera 20 is expressed by a coordinate in a coordinate space stored in storage 50. The coordinate space is a three-dimensional space defined by XYZ axes. Obtaining unit 12 obtains the position of camera 20 based on the detection value from position sensor 22 included in camera 20. The posture of camera 20 is a direction in which camera 20 faces, at the position of camera 20 described above, and it is expressed, for example, by an angle with respect to the XYZ axes or an angle around each axis. Obtaining unit 12 obtains the posture of camera 20 based on the detection value from inertial sensor 21 included in camera 20.

Controller 10 determines whether or not an object included in an image picked up by camera 20 is included in target range Rg1 (step S13). In the present embodiment, determination unit 13 makes determination based on the position and the posture of camera 20 obtained by obtaining unit 12 and the detection value from distance sensor 23.

Controller 10 performs image processing on the image picked up by camera 20, the image processing selected depending upon a result of determination by determination unit 13 (step S14). In image pick-up system 100 in the present embodiment, the mask processing is performed on an object determined as not being included in target range Rg1. The mask processing refers to processing for degrading viewability of a target region in an image, and includes, for example, pixelating processing. The mask processing includes also processing for superimposing a predetermined image on the target region.

Controller 10 has the image resulting from mask processing stored, for example, in a display buffer or storage 50 (step S15). Controller 10 determines whether or not it has accepted an image pick-up quitting instruction from the user (step S16). When controller 10 determines that it has not accepted the image pick-up quitting instruction from the user (NO in step S16), the process returns to step S12 and processing in steps S12 to S15 is repeated for an image for each one frame included in moving images picked up by camera 20. As described with reference to FIG. 2, camera 20 picks up moving pictures while it is moving. Therefore, contents shown in the raw image for each one frame included in the moving pictures picked up by camera 20 may vary. Similarly, the position and the posture of camera 20 obtained in step S12 may also vary for each one frame. When controller 10 determines that it has accepted the image pick-up quitting instruction from the user (YES in step S16), the process ends.

Thus, in image pick-up system 100, as controller 10 performs the flowchart shown in FIG. 5, the mask processing is performed on the object arranged in the range other than target range Rg1 shown in FIG. 2. Thus, in image pick-up system 100, the mask processing can be performed, with the object to be shown in the image and the object not to be shown in the image being distinguished from each other, without generation of a recognition model.

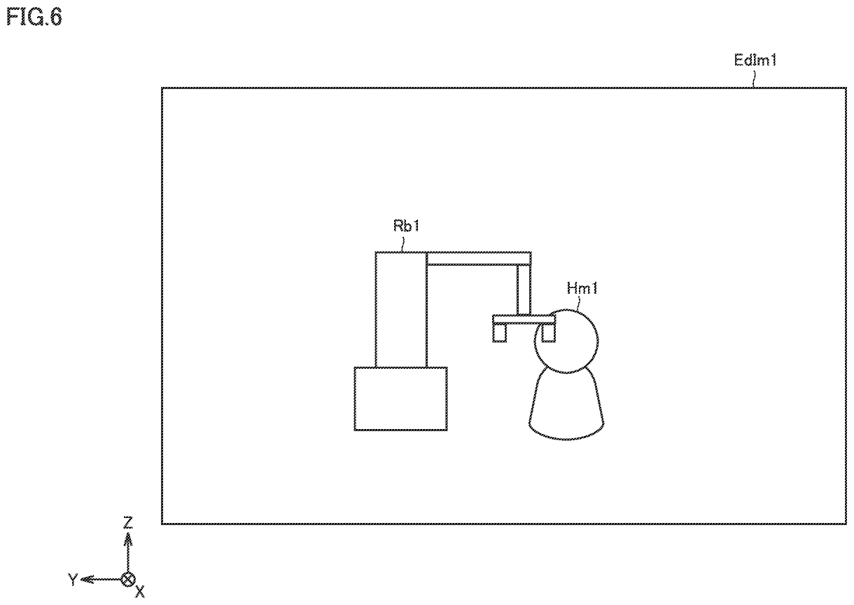

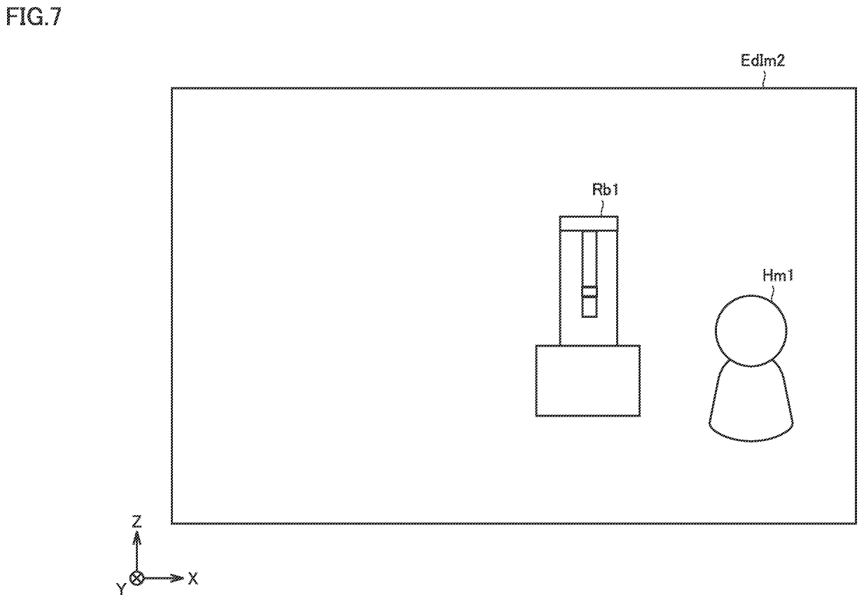

FIG. 6 is a diagram showing an image EdIm1 resulting from the mask processing on image RwIm1 shown in FIG. 5. FIG. 7 is a diagram showing an image EdIm2 resulting from the mask processing on image RwIm2 shown in FIG. 6. As shown in FIGS. 6 and 7, the object arranged in the range other than target range Rg1 is unrecognizable as a result of the mask processing.

As shown in FIG. 6, a region including an object which is an image pick-up target may be set as target range Rg1, or in contrast, a region including an object which is not an image pick-up target may be set as target range Rg1. For example, when an object including confidential information is arranged in target range Rg1 in FIG. 2, controller 10 performs the mask processing on target range Rg1.

In succession, an exemplary method of setting target range Rg1 will be described with reference to FIG. 8. FIG. 8 is a diagram showing a flowchart for setting target range Rg1. The flowchart shown in FIG. 8 is performed by controller 10 when it accepts an instruction to set target range Rg1 from the user.

Controller 10 initializes target range Rg1 (step S21). Specifically, in step S21, setting unit 11 initializes a storage area for target range Rg1 in storage 50.

Controller 10 obtains the position and the posture of camera 20 as an initial position and an initial posture (step S22). Specifically, in step S22, controller 10 obtains the position and the posture of camera 20 defined as the initial position and the initial posture based on detection values from inertial sensor 21 and position sensor 22. The position of camera 20 defined as the initial position is stored in storage 50 as the coordinate on the coordinate space. Similarly, the posture of camera 20 defined as the initial posture is stored in storage 50 as the direction in which camera 20 faces at the initial position of camera 20.

Controller 10 determines whether or not it has accepted from the user, information on target range Rg1 with respect to the initial position of camera 20 (step S23). The information on target range Rg1 is information on a region occupied by target range Rg1 on the coordinate space. For example, when target range Rg1 is in a shape of a cube, input device 30 accepts from the user, input of information indicating a coordinate how far ahead from the initial position of camera 20 in a direction of image pick-up is to be defined as a central position (a distance between the cube and camera 20) and information indicating a length of one side of the cube.

When controller 10 determines that it has not accepted the information on target range Rg1 (NO in step S23), it repeats the processing in step S23. When controller 10 determines that it has accepted the information on target range Rg1 (NO in step S23), controller 10 has a corresponding region on the coordinate space stored as target range Rg1 in storage 50, based on the information on target range Rg1 accepted from the user. In other words, setting unit 11 sets a spatial region occupied by the cube as target range Rg1, in accordance with the information on target range Rg1 accepted from the user.

Since the position of camera 20 and the position of target range Rg1 are stored on the same coordinate space, controller 10 can obtain relative relation between the position of camera 20 and the position of target range Rg1 by referring to the coordinate space. The relative relation includes a distance between camera 20 and target range Rg1 on the coordinate space, a direction in which target range Rg1 is located with camera 20 being defined as the center, and the like.

Even when camera 20 moves, obtaining unit 12 obtains the position and the posture of camera 20 for each one frame and hence controller 10 can calculate an amount of movement from the initial position and the initial posture. In other words, controller 10 updates the position and the posture of camera 20 on the coordinate space when camera 20 moves. Therefore, even after movement of camera 20, controller 10 can calculate relative relation of the position and the posture of camera 20 after movement of the camera with the position of target range Rg1.

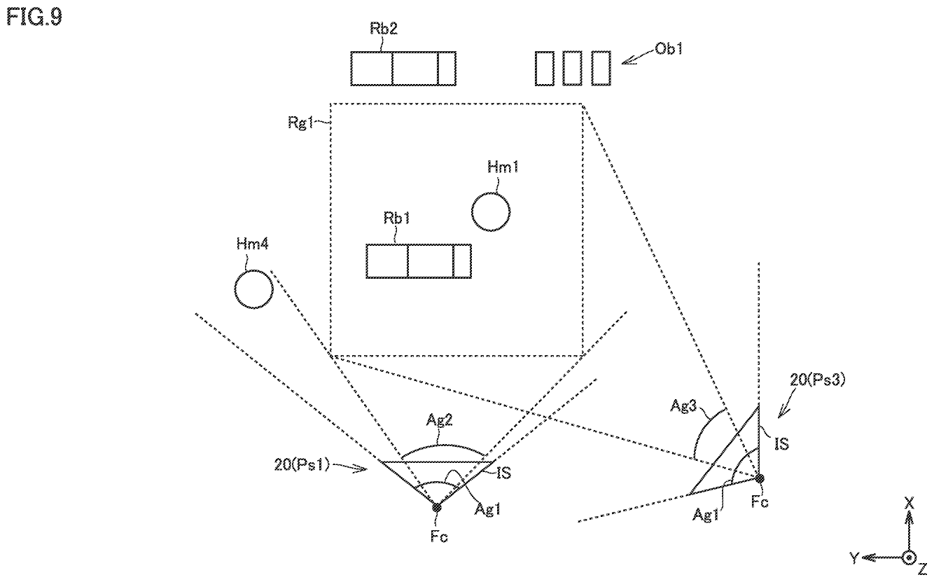

A method of determining whether or not the object included in the image is included in target range Rg1 will be described below. As described above, controller 10 makes determination based on the position and the posture of camera 20 obtained by obtaining unit 12 and the detection value from distance sensor 23 included in camera 20. FIG. 9 illustrates an example in which determination is made only based on the position and the posture of camera 20. As described with reference to FIG. 8, obtaining unit 12 obtains as the initial position and the initial posture, the position and the posture of camera 20 at the time of setting of target range Rg1.

As described above, after obtaining unit 12 obtains the initial position and the initial posture of camera 20, it continues to obtain the position and the posture of camera 20 for each one frame of moving pictures. Therefore, determination unit 13 can obtain relative relation of the position and the posture of camera 20 with the position of target range Rg1 even after camera 20 moves. In other words, controller 10 can obtain relative positional relation between camera 20 and target range Rg1 based on comparison of the position and the posture of camera 20 after movement of camera 20 with the stored information on target range Rg1.

FIG. 9 is a diagram showing relation of the position and the posture of camera 20 with target range Rg1. FIG. 9 shows an example in which setting unit 11 sets target range Rg1 while camera 20 is located at position Ps1. In other words, position Ps1 is the initial position and the initial posture of camera 20.

FIG. 9 shows an image sensor IS of camera 20 and a focus Fc of image sensor IS. An angle Ag1 is an angle of view of camera 20. Determination unit 13 can calculate as an angle Ag2, an angle within which target range Rg1 is projected, the angle being within angle Ag1 representing the angle of view of camera 20, based on the relative relation of the position and the posture of camera 20 with the position of target range Rg1. As shown in FIG. 9, a range corresponding to angle Ag2 on image sensor IS includes robot Rb2 and object Ob1 in addition to robot Rb1 and human operator Hm1. On the other hand, a range corresponding to angle Ag2 on image sensor IS does not include human operator Hm4.

Therefore, controller 10 can determine that human operator Hm4 is not included in target range Rg1 based on the relative relation of the position and the posture of camera 20 with the position of target range Rg1. In other words, controller 10 can determine that at least an object in the range not corresponding to angle Ag2 on image sensor IS is not included in target range Rg1.

When camera 20 moves to a position Ps3 as well, similarly, controller 10 can calculate as an angle Ag3, an angle within which target range Rg1 is projected, the angle being within angle Ag1 representing the angle of view of camera 20, based on the relative relation of the position and the posture of camera 20 after movement of the camera with the position of target range Rg1. Therefore, controller 10 can determine that at least an object in a range not corresponding to angle Ag3 on image sensor IS is not included in target range Rg1.

Controller 10 can thus determine, when the camera is located at position Ps1, that human operator Hm4 is not included in target range Rg1 based on the position and the posture of camera 20. If presence within target range Rg1 is determined only based on the angle of view, however, for example, an object included in a range corresponding to angle Ag2 but not included in target range Rg1, such as robot Rb2 and object Ob1, is unrecognizable.

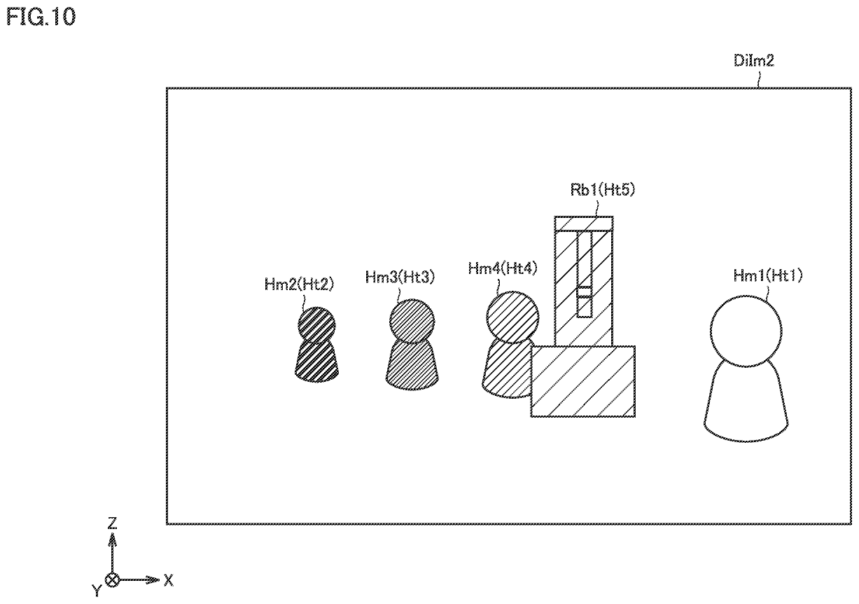

In the present embodiment, whether or not robot Rb2 and object Ob1 are included in target range Rg1 is determined by measurement of a distance from camera 20 to the object with the use of distance sensor 23. FIG. 10 is a diagram showing an image DiIm2 which is combination of a result of detection by distance sensor 23 and image RwIm1 from camera 20. Distance sensor 23 detects a distance between the object included in the image picked up by camera 20 and camera 20.

In image DiIm2 shown in FIG. 10, human operators Hm1 to Hm4 and robot Rb1 included in the image are provided with hatchings Ht1 to Ht5 different in accordance with the distance between the object and camera 20. Though FIG. 10 shows an example in which hatchings Ht1 to Ht5 are provided for the sake of description, the distance between the object and camera 20 may be expressed by a type of a color or gradation of a color,

Controller 10 can calculate a distance to a boundary in the Y-axis direction of target range Rg1 based on the relative relation of the position and the posture of camera 20 with the position of target range Rg1. Therefore, controller 10 can determine that human operators Hm2 to Hm4 arranged in the rear of target range Rg1 (on the side of the positive direction in the Y-axis direction) are not included in target range Rg1. Controller 10 can thus determine whether or not an object arranged in a range corresponding to angle Ag2 on image sensor IS is included also in target range Rg1. Controller 10 performs the mask processing on the object determined as not being included in target range Rg1.

Thus, image pick-up system 100 in the present embodiment sets target range Rg1, and when it determines that the object included in the image is not included in target range Rg1, it performs the mask processing. Therefore, a recognition model for recognizing human operators Hm2 to Hm4, robot Rb2, object Ob1, and the like which are objects arranged in a range other than target range Rg1 does not have to be generated. Thus, image pick-up system 100 can distinguish between the object to be shown in the image and the object not to be shown in the image without generation of the recognition model and achieve suppression of increase in cost.

### First Modification

In the present embodiment, an example in which information on target range Rg1 is accepted from the user through input device 30 in connection with setting of target range Rg1 is described. In a first modification, image pick-up system 100 that has the user set target range Rg1 based on an image picked up by camera 20, instead of input by the user of direct information on target range Rg1 such as the distance from camera 20 or a length of a side of the cube, is described. Description of features in image pick-up system 100 in the first modification the same as those in image pick-up system 100 in the present embodiment will not be repeated.

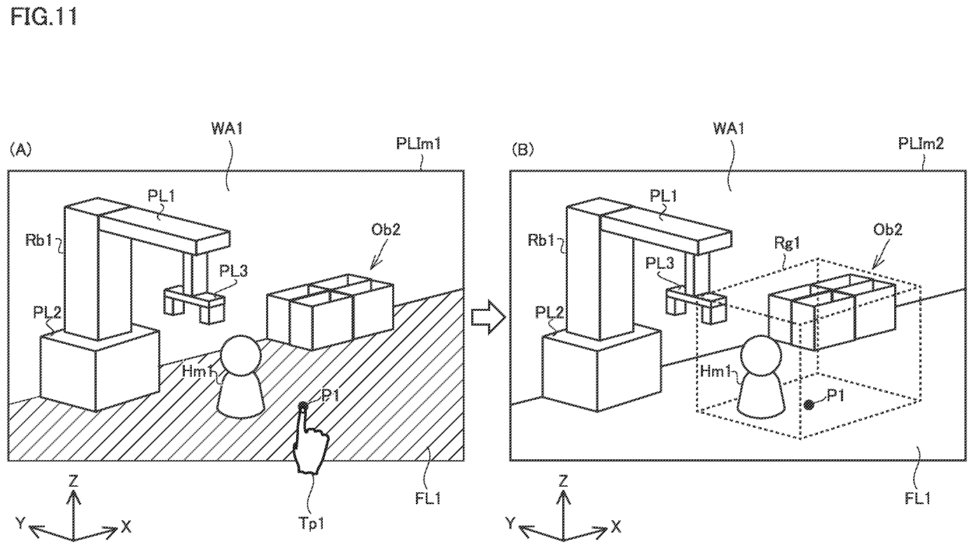

FIG. 11 is a diagram for illustrating setting of target range Rg1 based on plane detection. A library in various AR systems can be applied to processing for plane detection. For example, a library that can be used in an environment for development of Unity, ARkit (trademark), or the like may be applied. Controller 10 uses such a library to analyze an image picked up by camera 20 to thereby detect a plane substantially in parallel to an XY plane perpendicular to the vertical direction. FIG. 11 (A) shows an image PLIm1 after plane detection. Controller 10 obtains information on a position on the coordinate space of a floor FL1 by plane detection.

In image PLIm1, human operator Hm1, robot Rb1, and an object Ob2 are shown. In image PLIm1, a wall WA1 and floor FL1 are shown. Human operator Hm1, robot Rb1, and object Ob2 are each arranged on floor FL1. Robot Rb1 and object Ob2 are arranged such that a part of them faces wall WA1.

In the example in FIG. 11, controller 10 detects planes PL1, PL2, and PL3 which are parts of robot Rb1 and floor FL1 as surfaces in parallel to the XY plane. Furthermore, controller 10 has the plane having an area equal to or larger than an area where an object can be arranged in the detected planes colored and has that plane shown on display device 40. The area in which the object can be arranged is defined in advance, and it is, for example, one square meter.

In the example in FIG. 11, controller 10 has floor FL1 having an area not smaller than one square meter colored and has image PLIm1 shown. Controller 10 has the user select a coordinate for setting of target range Rg1 in colored floor FL1. In the example in FIG. 11, in a screen that shows an image where image PLIm1 is shown, selection Tp1 of a part of floor FL1 has been made by the user. Controller 10 obtains a coordinate P1 on the coordinate space corresponding to a point selected in selection Tp1 by the user. In other words, selection Tp1 is information indicating coordinate P1 included in floor FL1.

Based on selection of the position corresponding to coordinate P1 on floor FL1 in the shown screen, controller 10 sets a region based on coordinate P1 as target range Rg1. FIG. 11 (B) is a diagram showing target range Rg1 set based on selection Tp1. In the example in FIG. 11, a cube having coordinate P1 defined as the center of a bottom surface is shown as target range Rg1. Controller 10 may define coordinate P1 as the center of the cube or as any corner of eight corners of the cube, rather than the center of the bottom surface. Setting unit 11 may change target range Rg1 that has been set once. In other words, when target range Rg1 has already been set, a plane is detected as shown in FIG. 11 and setting unit 11 newly sets target range Rg1 based on the coordinate newly selected by the user.

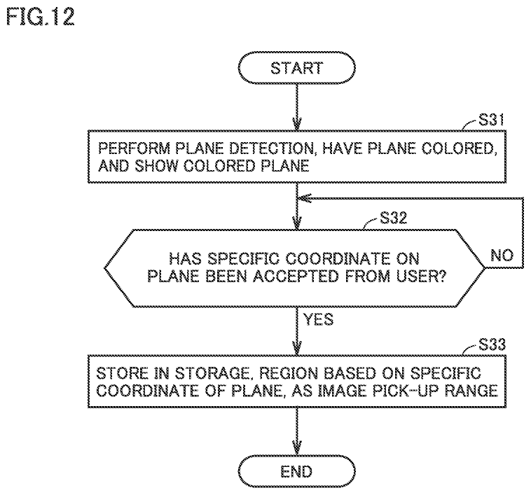

FIG. 12 is a diagram showing a flowchart of a method of setting target range Rg1 based on plane detection. Controller 10 detects a plane in an image picked up by camera 20, has the plane colored, and has image PLIm1 shown (step S31). Controller 10 determines whether or not it has accepted information indicating coordinate P1 included in the plane from the user through input device 30 (step S32). When controller 10 has not accepted information indicating coordinate P1 (NO in step S32), it repeats processing in step S32.

When controller 10 accepts the information indicating coordinate P1 (YES in step S32), setting unit 11 included in controller 10 sets a region based on accepted coordinate P1 as target range Rg1 (step S33). In other words, setting unit 11 has information on target range Rg1 stored in storage 50. When the information on target range Rg1 has already been stored in storage 50, setting unit 11 changes the information to information on new target range Rg1 selected by the user.

Thus, in image pick-up system 100 in the first modification, target range Rg1 is set based on plane detection. Thus, in image pick-up system 100, which position is to be set as target range Rg1 can easily be set by the user based on the image picked up by camera 20.

### Second Modification

In the present embodiment, an example in which the position and the posture of camera 20 are obtained based on inertial sensor 21 and position sensor 22 is described. In the first modification, an example in which target range Rg1 is set based on plane detection is described. In a second modification, an example in which the position and the posture of camera 20 are obtained and target range Rg1 is set based on a marker Mk1 arranged in the real space will be described. Description of features in image pick-up system 100 in the second modification the same as those in image pick-up system 100 in the present embodiment will not be repeated.

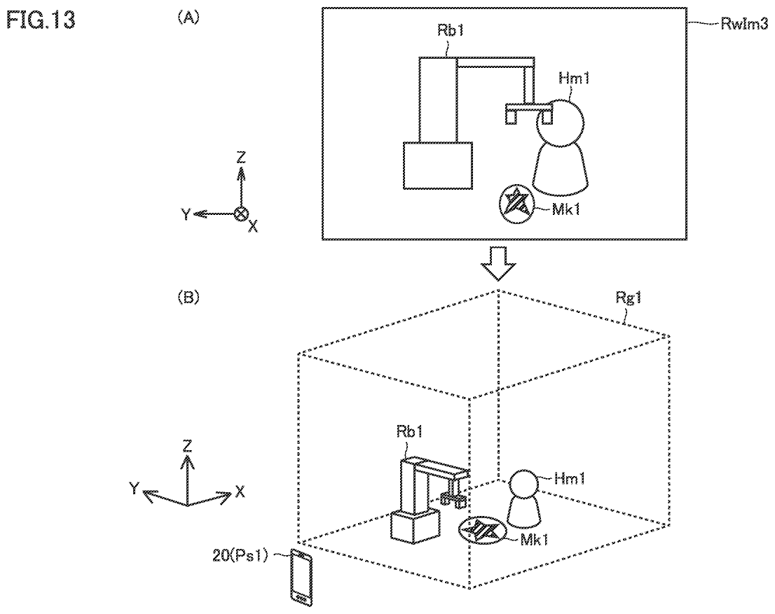

FIG. 13 is a diagram for illustrating a method of setting target range Rg1 with the use of marker Mk1. FIG. 13 (A) is a diagram showing an image RwIm3 picked up by camera 20. FIG. 13 (B) is a diagram showing set target range Rg1. Image RwIm3 shows marker Mk1 in addition to human operator Hm1 and robot Rb1. Though marker Mk1 is a mark in a star shape in the example in FIG. 13, it may be, for example, a QR code (trademark).

Setting unit 11 sets as target range Rg1, a region based on marker Mk1 projected in image RwIm3. Controller 10 extracts marker Mk1 from image RwIm3 and obtains the position of marker Mk1 on the coordinate space by image analysis based on an amount of change from a reference shape of marker Mk1. The reference shape refers to a size and a shape of marker Mk1 in the real space. The reference shape of marker Mk1 is stored in advance in storage 50. Controller 10 calculates the amount of change from the reference shape of marker Mk1 projected in image RwIm3.

The amount of change of the shape means a degree of geometrical transformation from the reference shape. Specifically, the amount of change may include an expansion and contraction ratio, an angle of rotation, a rate of shear, or the like for conformity of the reference shape with marker Mk1 projected in image RwIm3. Controller 10 can thus calculate the distance from the position of camera 20 to marker Mk1 and the posture of marker Mk1. In other words, controller 10 obtains position information of marker Mk1 relative to the position of camera 20. Setting unit 11 defines the region based on the position information of marker Mk1 as target range Rg1.

In the example in FIG. 13 (B), a cube, with marker Mk1 being defined as the center of the bottom surface thereof, is shown as target range Rg1. Controller 10 may have marker Mk1 located at the center of the cube or at any one of eight corners of the cube, rather than the center of the bottom surface.

Controller 10 obtains the position and the posture of camera 20 relative to the position of marker Mk1 by image analysis. Since target range Rg1 is set based on the position of marker Mk1, controller 10 can obtain relative relation of the position and the posture of camera 20 with target range Rg1. In other words, determination unit 13 can determine whether or not target range Rg1 is located within the angle of view of camera 20.

Thus, in image pick-up system 100 in the second modification, even when camera 20 does not include inertial sensor 21, position sensor 22, and distance sensor 23, target range Rg1 can be set based on the amount of transformation from the reference shape of marker Mk1 included in the image picked up by camera 20, so that the position and the posture of camera 20 can be obtained. Since inertial sensor 21, position sensor 22, and distance sensor 23 thus do not have to be provided in the second modification, cost can be reduced.

### Third Modification

In the second modification, an example in which the position and the posture of camera 20 are obtained and target range Rg1 is set based on marker Mk1 included in the image is described. In a third modification, an example in which, even when marker Mk1 is not projected, the position and the posture of camera 20 are obtained and target range Rg1 is set based on change of moving images picked up by camera 20 will be described. Description of features in image pick-up system 100 in the third modification the same as those in image pick-up system 100 in the present embodiment will not be repeated.

Controller 10 in the third modification creates (maps) topography information of the real space around camera 20 based on change of contents in an image for each one frame included in moving images based on a visual simultaneous localization and mapping (SLAM) technology. Controller 10 may perform mapping processing based on a structure from motion (SfM) technology instead of the visual SLAM technology, or may combine these technologies.

The mapping processing is also referred to as environmental map creation processing, and it is processing for creating 3D data representing the real space around camera 20. Controller 10 obtains the 3D data representing the real space around camera 20 through the mapping processing, and has the 3D data stored on the coordinate space of storage 50. Controller 10 may convert the 3D data representing the real space around camera 20 into map information or the like at the time when the XY plane is two-dimensionally viewed and may have the resultant map information stored in storage 50. The 3D data representing the real space or the map information based thereon corresponds to the “specifying information” in the present disclosure. Controller 10 generates the specifying information based on the visual SLAM technology or the SfM technology.

Controller 10 has the 3D data representing the real space shown on display device 40. As described with reference to FIG. 11, controller 10 has the user select the coordinate included in the 3D data on the coordinate space and sets the region based on the coordinate as target range Rg1.

Controller 10 estimates a position of camera 20 itself based on the visual SLAM technology. In other words, controller 10 estimates the position of camera 20 itself in topography information around camera 20 created in the mapping processing. Controller 10 may estimate the position of camera 20 itself based on the SfM technology and a visual odometry (VO) technology instead of the visual SLAM technology, or may combine these technologies.

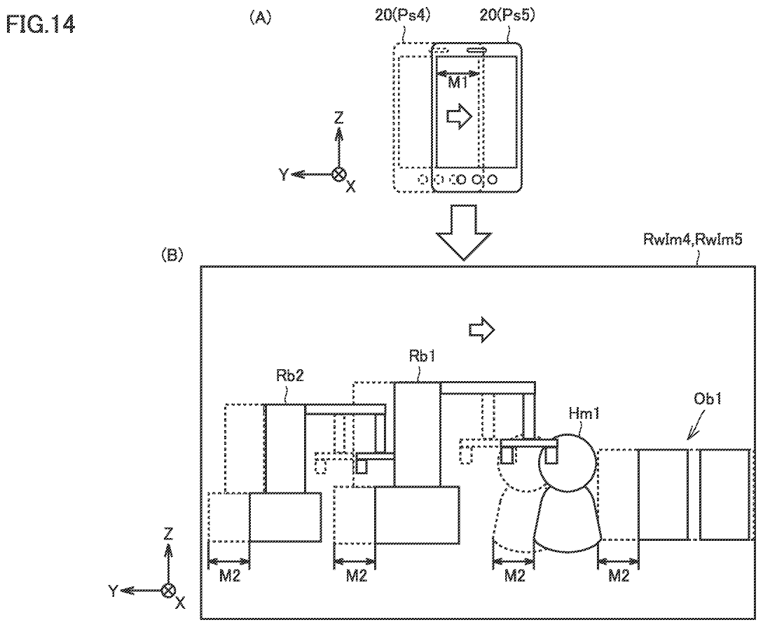

A method of estimating the position and the posture of camera 20 by image analysis based on the visual SLAM technology or the like will be described below. FIG. 14 is a diagram for illustrating relation between an amount of change of an image and an amount of movement of camera 20. FIG. 14 (A) is a diagram showing movement of camera 20 from a position Ps4 to another position Ps5. FIG. 14 (B) is a diagram showing change of an image RwIm4, RwIm5 at the time when camera 20 moves from position Ps4 to another position Ps5.

Controller 10 can estimate by image analysis, an amount of movement M1 from position Ps4 of camera 20 itself based on an amount of change M2 of the position between frames, of the object included in the image as shown in FIG. 14 (B). Thus, in the third modification, obtaining unit 12 obtains the position and the posture of camera 20 relative to the topography information created in the mapping processing based on amount of movement M1 of camera 20 itself.

The distance between camera 20 and the object included in the image may be estimated with the use of an estimation model generated by machine learning. Specifically, controller 10 estimates the distance between the object arranged in the real space and camera 20 with the use of the estimation model generated by learning sample images.

Thus, image pick-up system 100 in the third modification can obtain the position and the posture of camera 20 and set target range Rg1 without including inertial sensor 21, position sensor 22, and distance sensor 23 as in the second modification. Therefore, image pick-up system 100 in the third modification can also achieve reduction in cost. Furthermore, image pick-up system 100 in the third modification can obtain the position and the posture of camera 20 and set target range Rg1 without arrangement of marker Mk1 in the real space.

### Fourth Modification

In the third modification, the configuration in which the topography information of the real space around camera 20 is created (mapped) based on change of contents in the image for each one frame included in moving images based on the visual SLAM technology is described. In a fourth modification, an example in which 3D data representing topography information of the real space is prepared in advance will be described. Description of features in image pick-up system 100 in the fourth modification the same as those in image pick-up system 100 in the present embodiment will not be repeated.

The topography information such as the 3D data may be generated not only based on the visual SLAM technology but also with the use of LIDAR or the like.

The topography information such as the 3D data may be published on the Internet from a point of view of preparation for disasters by a public organization such as a municipality.

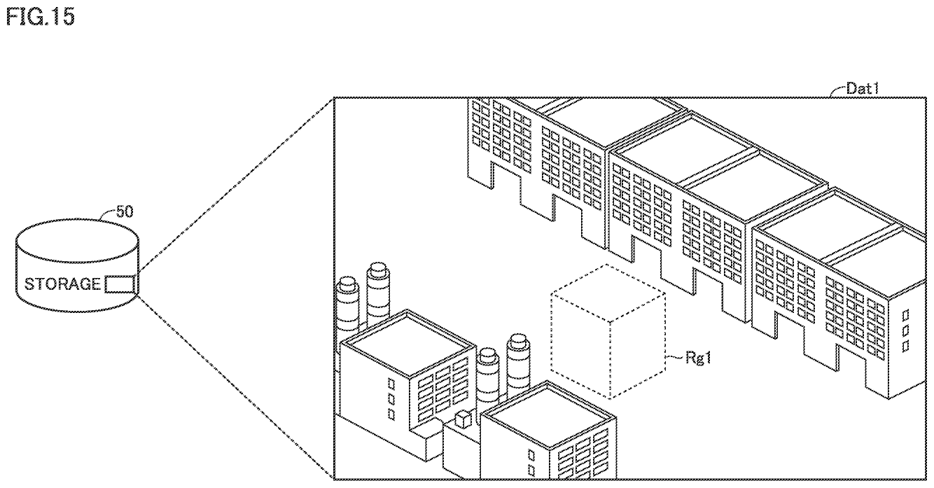

FIG. 15 is a diagram showing storage in advance of 3D data Dat1 representing the real space in storage 50. In the fourth modification, the topography information such as 3D data Dat1 representing the real space is stored in advance on the coordinate space in storage 50. Controller 10 has 3D data Dat1 representing the real space shown on display device 40 or the like and has the user set target range Rg1 in 3D data Dat1.

Controller 10 obtains the position and the posture of camera 20 on the coordinate space based on detection values from inertial sensor 21 and position sensor 22. In other words, controller 10 can obtain relative relation of the position and the posture of camera 20 with the position of target range Rg1.

Thus, in image pick-up system 100 in the fourth modification, 3D data Dat1 representing the real space is stored in advance in storage 50, and setting unit 11 sets target range Rg1 based on 3D data Dat1. Thus, in image pick-up system 100 in the fourth modification, determination unit 13 can determine whether or not the object included in the angle of view of camera 20 is included in target range Rg1. Therefore, since image pick-up system 100 in the fourth modification does not have to include distance sensor 23, it can achieve reduction in cost.

### Fifth Modification

The configuration in which the position and the posture of camera 20 are obtained based on the detection values from inertial sensor 21 and position sensor 22 in image pick-up system 100 in the present embodiment is described. In a fifth modification, a configuration in which the position and the posture of camera 20 are obtained based on an image picked up by a camera 25 different from camera 20 will be described. Description of features in an image pick-up system 100A in the fifth modification the same as those in image pick-up system 100 in the present embodiment will not be repeated.

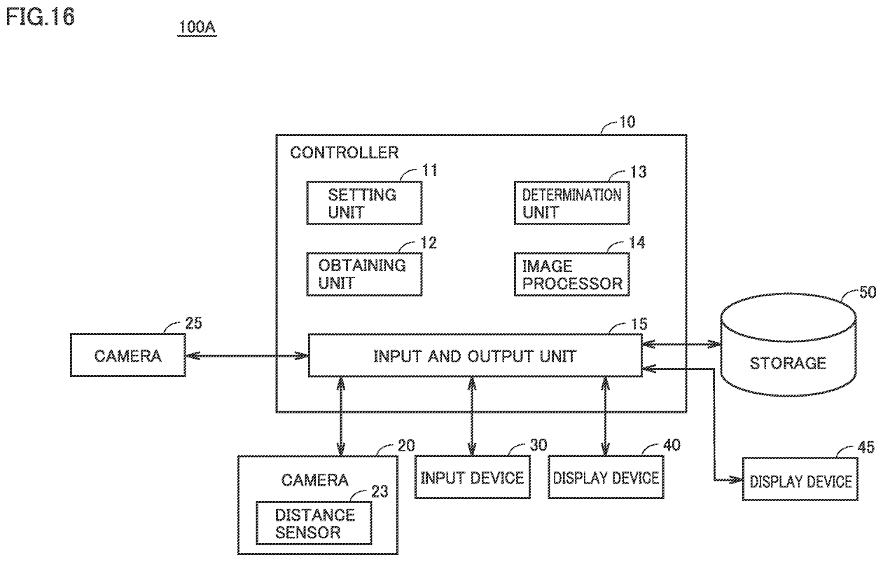

FIG. 16 is a block diagram showing the configuration of image pick-up system 100A in the fifth modification. Image pick-up system 100A further includes camera 25 and a display device 45. Camera 20 does not include inertial sensor 21 and position sensor 22.

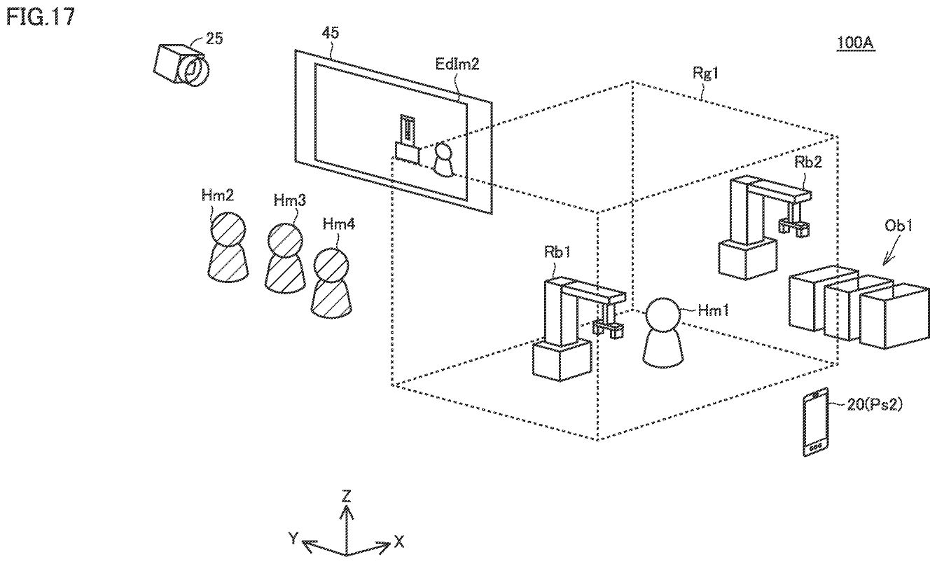

FIG. 17 is a diagram for illustrating image pick-up by image pick-up system 100A in the fifth modification. FIG. 17 shows camera 25 that picks up an image of camera 20 and display device 45. Each of camera 25 and display device 45 is separate from the smartphone in the present embodiment and wirelessly connected to controller 10 stored in the smartphone.

Camera 25 is a fixed camera, and it is, for example, a stationary camera such as a surveillance camera. Obtaining unit 12 obtains by image analysis, the position and the posture of camera 20 based on the amount of change from the reference shape of the geometry of the smartphone included in the image picked up by camera 25. Camera 25 corresponds to the “second camera” in the present disclosure.

Controller 10 obtains the position information of camera 20 as in obtainment of the position information of marker Mk1 on the coordinate space based on the amount of change of the shape of marker Mk1 from the reference shape in the second modification. In other words, the geometry in the real space of the smartphone where camera 20 is stored is stored as the reference shape in storage 50. Controller 10 obtains at least one of the position and the posture of camera 20 based on the amount of change from the reference shape of the smartphone to the geometry of the smartphone included in the image picked up by camera 25. Controller 10 may obtain only the posture of camera 20 from the image picked up by camera 25 and may obtain the position of camera 20 with the use of the position sensor. Alternatively, controller 10 may obtain only the position of camera 20 from the image picked up by camera 25 and may obtain the posture of camera 20 with the use of the inertial sensor.

Thus, in image pick-up system 100A in the fifth embodiment, obtaining unit 12 can obtain the position and the posture of camera 20 without using at least one of inertial sensor 21 and position sensor 22. Therefore, image pick-up system 100A in the fifth modification can also achieve reduction in cost. Determination unit 13 determines whether or not the object included in the image picked up by camera 20 is included in target range Rg1 based on the position and the posture of camera 20 on the coordinate space obtained by analysis of the image picked up by camera 25.

Image processor 14 performs the mask processing on the object determined as not being included in target range Rg1. In the example in FIG. 17, image processor 14 performs the mask processing on image RwIm2 picked up from position Ps2 and generates image EdIm2. As shown in FIG. 17, controller 10 has image EdIm2 shown on display device 45. Human operators Hm2 to Hm4 arranged in the range other than target range Rg1 can thus confirm that they are not shown in image EdIm2 as a result of the appropriately performed mask processing.

### [Aspects]

Illustrative embodiments described above are understood by a person skilled in the art as specific examples of aspects below.

(Clause 1) An image pick-up system according to one aspect includes a first camera that picks up an image of an object arranged in a real space and a controller. The controller includes a setting unit that sets a first range in the real space, an obtaining unit that obtains a position and a posture of the first camera, a determination unit that determines whether an object included in the image picked up by the first camera is included in the first range based on the position and the posture of the first camera, and an image processor that performs image processing on the image picked up by the first camera, the image processing selected depending upon a result of determination by the determination unit.

According to the image pick-up system described in Clause 1, an object to be shown in the image and an object not to be shown in the image can be distinguished from each other without generation of a recognition model and increase in cost can be suppressed.

(Clause 2) The image processor according to Clause 1 performs mask processing on the image picked up by the first camera, aiming at an object determined as not being included in the first range by the determination unit.

According to the image pick-up system described in Clause 2, the object determined as not being included in the first range in the image picked up by the first camera can be hidden.

(Clause 3) The first camera according to Clause 1 or 2 includes an inertial sensor. The obtaining unit obtains based on a detection value from the inertial sensor, the posture of the first camera with respect to the posture of the first camera at the time of setting of the first range.

According to the image pick-up system described in Clause 3, the inertial sensor can be used to obtain information on the posture of the first camera.

(Clause 4) The first camera according to any one of Clauses 1 to 3 includes a position sensor. The obtaining unit obtains the position of the first camera based on a detection value from the position sensor.

According to the image pick-up system described in Clause 4, the position sensor can be used to obtain information on the position of the first camera.

(Clause 5) The obtaining unit according to Clause 1 obtains at least one of the position and the posture of the first camera based on an amount of change of the position in the image of the object included in the image picked up by the first camera.

According to the image pick-up system described in Clause 5, without the inertial sensor and the position sensor, information on the position and the posture of the first camera can be obtained from moving images picked up by a monocular camera and cost can be reduced.

(Clause 6) The obtaining unit according to Clause 5 obtains the position and the posture of the first camera based on at least one of a visual simultaneous localization and mapping (SLAM) technology, a structure from motion (SfM) technology, and a visual odometry (VO) technology.

According to the image pick-up system described in Clause 6, without the inertial sensor and the position sensor, information on the position and the posture of the first camera can be obtained from moving images picked up by a monocular camera based on the SLAM technology and cost can be reduced.

(Clause 7) The obtaining unit according to Clause 1 extracts a marker included in the image and obtains the position and the posture of the first camera based on an amount of change from a reference shape of the marker.

According to the image pick-up system described in Clause 7, without the inertial sensor and the position sensor, by image pick-up of the marker arranged in the real space, information on the position and the posture of the first camera can be obtained from moving images picked up by a monocular camera and cost can be reduced.

(Clause 8) A second camera that picks up an image of the first camera according to Clause 1 is further provided. The obtaining unit obtains the position and the posture of the first camera based on an amount of change from a reference shape of the first camera included in the image picked up by the second camera.

According to the image pick-up system described in Clause 8, without the inertial sensor and the position sensor, information on the position and the posture of the first camera can be obtained from the image picked up by the second camera and cost can be reduced.

(Clause 9) The determination unit according to any one of Clauses 1 to 8 determines whether the object included in the image is included in the first range based on a distance between the object arranged in the real space and the first camera.

According to the image pick-up system described in Clause 9, as shown in FIG. 9, in addition to the information as to at which angle within the angle of view of the first camera the target range is located, arrangement of the object with respect to a direction of image pick-up can be obtained. Therefore, whether or not the object included in the image is included in the target range can more accurately be determined.

(Clause 10) A distance sensor that detects the distance between the object arranged in the real space according to Clause 9 and the first camera is further provided.

According to the image pick-up system described in Clause 10, the distance sensor can be used to detect the distance between the object and the first camera.

(Clause 11) The distance between the object arranged in the real space and the first camera is estimated based on an estimation model generated by machine learning according to Clause 9 and the image picked up by the first camera.

According to the image pick-up system described in Clause 11, since the distance between the object and the first camera can be detected without the use of the distance sensor, cost can be reduced.

(Clause 12) The determination unit according to any one of Clauses 1 to 8 determines whether or not the object included in the image picked up by the first camera is included in the first range based on the position and the posture of the first camera.

According to the image pick-up system described in Clause 12, a region occupied by the first range within the angle of view of the first camera can be determined only based on the position and the posture of the first camera as shown in FIG. 9, and the object included in the region can be determined as being included in the first range.

(Clause 13) An input device according to any one of Clauses 1 to 12 is further provided. The input device accepts position information of the first range with respect to the position and the posture of the first camera obtained by the obtaining unit. The setting unit sets the first range based on the position information of the first range.

According to the image pick-up system described in Clause 13, the position of the first range can be set based on the position information of the first range accepted from the user through the input device.

(Clause 14) An input device according to any one of Clauses 1 to 12 is further provided. The controller detects a plane perpendicular to a vertical direction in the image picked up by the first camera. When a coordinate in an image inputted by a user is included in the detected plane, the setting unit sets as the first range, a region defined based on the coordinate.

According to the image pick-up system described in Clause 14, the user can intuitively set at which position the target range is to be arranged in the plane detected by plane detection, based on the image picked up by camera 20.

(Clause 15) The setting unit according to any one of Clauses 1 to 12 extracts a marker included in the image and sets the first range based on how an amount of change from a reference shape of the marker is projected.

According to the image pick-up system described in Clause 15, the target range can be set simply by arranging the marker in the real space.

(Clause 16) A storage according to any one of Clauses 1 to 12 is further provided. Specifying information representing the real space is stored in the storage. The setting unit sets the first range based on the specifying information.

According to the image pick-up system described in Clause 16, the first range can be set based on the specifying information representing the real space.

(Clause 17) The controller according to Clause 16 creates the specifying information based on a visual simultaneous localization and mapping (SLAM) technology or a structure from motion (SfM) technology.

According to the image pick-up system described in Clause 17, the specifying information can be created by image pick-up by the first camera without preparation in advance of the specifying information such as 3D data representing the real space.

(Clause 18) The setting unit according to any one of Clauses 1 to 17 changes the first range that has been set based on an input from a user.

According to the image pick-up system described in Clause 18, the set target range can be changed even during image pick-up by the first camera.

(Clause 19) A display device according to any one of Clauses 2 to 18 is further provided. The controller has the display device show the image resulting from the mask processing by the image processor.

According to the image pick-up system described in Clause 19, whether or not the mask processing by the image processor is appropriately performed can readily be checked.

(Clause 20) An image pick-up method according to one aspect is an image pick-up method of picking up, with a camera, an image of an object arranged in a real space. The image pick-up method includes setting a first range in the real space, obtaining a position and a posture of the camera, determining whether an object included in an image picked up by the camera is included in the first range based on the position and the posture of the camera, and performing image processing on the image picked up by the camera, the image processing selected depending upon a result of determination in the determining.

According to the image pick-up method described in Clause 20, an object to be shown in the image and an object not to be shown in the image can be distinguished from each other without generation of a recognition model and increase in cost can be suppressed.

In the embodiment and the modifications described above, combination of features described in the embodiment as appropriate, inclusive of combination not mentioned in the specification, is originally intended within the scope where no inconvenience or inconsistency is caused.

It should be understood that the embodiment disclosed herein is illustrative and non-restrictive in every respect. The scope of the present invention is defined by the terms of the claims rather than the description above and is intended to include any modifications within the scope and meaning equivalent to the terms of the claims.

### REFERENCE SIGNS LIST

10 controller; 11 setting unit; 12 obtaining unit; 13 determination unit; 14 image processor; 20, 25 camera; 21 inertial sensor; 22 position sensor; 23 distance sensor; 30 input device; 40, 45 display device; 50 storage; 100, 100A image pick-up system; Ag1 to Ag3 angle; Ob1, Ob2 object; Dat1 data; EdIm1, EdIm2, PLIm1, PLIm2, RwIm1 to RwIm5 image; FL1 floor; Fc focus; Hm1 to Hm4 human operator; Ht1 to Ht5 hatching; IS image sensor; M1 amount of movement; Mk1 marker; P1 coordinate; PL1 plane; Ps1 to Ps5 position; Rb1, Rb2 robot; Rg1 target range; Tp1 selection; WA1 wall

1. An image pick-up system comprising:
a first camera that picks up an image of an object arranged in a real space; and
a controller, wherein
the controller includes
a setting unit that sets a first range in the real space,
an obtaining unit that obtains a position and a posture of the first camera,
a determination unit that determines whether an object included in the image picked up by the first camera is included in the first range based on the position and the posture of the first camera, and
an image processor that performs image processing on the image picked up by the first camera, the image processing selected depending upon a result of determination by the determination unit.

2. The image pick-up system according to claim 1, wherein
the image processor is configured to perform mask processing on the image picked up by the first camera, aiming at an object determined as not being included in the first range by the determination unit.

3. The image pick-up system according to claim 1, wherein
the first camera includes an inertial sensor, and
the obtaining unit is configured to obtain based on a detection value from the inertial sensor, the posture of the first camera with respect to the posture of the first camera at time of setting of the first range.

4. The image pick-up system according to claim 1, wherein
the first camera includes a position sensor, and
the obtaining unit is configured to obtain the position of the first camera based on a detection value from the position sensor.

5. The image pick-up system according to claim 1, wherein
the obtaining unit is configured to obtain at least one of the position and the posture of the first camera based on an amount of change of the position in the image of the object included in the image picked up by the first camera.

6. The image pick-up system according to claim 5, wherein
the obtaining unit is configured to obtain the position and the posture of the first camera based on at least one of a visual simultaneous localization and mapping (SLAM) technology, a structure from motion (SfM) technology, and a visual odometry (VO) technology.

7. The image pick-up system according to claim 1, wherein
the obtaining unit is configured to extract a marker included in the image and obtains the position and the posture of the first camera based on an amount of change from a reference shape of the marker.

8. The image pick-up system according to claim 1, further comprising a second camera that picks up an image of the first camera, wherein
the obtaining unit is configured to obtain the position and the posture of the first camera based on an amount of change from a reference shape of the first camera included in the image picked up by the second camera.

9. The image pick-up system according to claim 1, wherein
the determination unit is configured to determine whether the object included in the image is included in the first range based on a distance between the object arranged in the real space and the first camera.

10. The image pick-up system according to claim 9, further comprising a distance sensor that detects the distance between the object arranged in the real space and the first camera.

11. The image pick-up system according to claim 9, wherein
the controller is configured to estimate the distance between the object arranged in the real space and the first camera based on an estimation model generated by machine learning and the image picked up by the first camera.

12. The image pick-up system according to claim 1, wherein
the determination unit is configured to determine whether or not the object included in the image picked up by the first camera is included in the first range based on the position and the posture of the first camera.

13. The image pick-up system according to claim 1, further comprising an input device, wherein
the input device is configured to accept position information of the first range with respect to the position and the posture of the first camera obtained by the obtaining unit, and
the setting unit is configured to set the first range based on the position information of the first range.

14. The image pick-up system according to claim 1, further comprising an input device, wherein
the controller is configured to detect a plane perpendicular to a vertical direction in the image picked up by the first camera, and
when a coordinate in an image inputted by a user is included in the detected plane, the setting unit is configured to set as the first range, a region defined based on the coordinate.

15. The image pick-up system according to claim 1, wherein
the setting unit is configured to extract a marker included in the image and sets the first range based on an amount of change from a reference shape of the marker.

16. The image pick-up system according to claim 1, further comprising a storage, wherein
specifying information representing the real space is stored in the storage, and
the setting unit is configured to set the first range based on the specifying information.

17. The image pick-up system according to claim 16, wherein
the controller is configured to create the specifying information based on a visual simultaneous localization and mapping (SLAM) technology or a structure from motion (SfM) technology.

18. The image pick-up system according to claim 1, wherein
the setting unit is configured to change the first range that has been set based on an input from a user.

19. The image pick-up system according to claim 2, further comprising a display device, wherein
the controller is configured to have the display device show the image resulting from the mask processing by the image processor.

20. An image pick-up method of picking up, with a camera, an image of an object arranged in a real space, the image pick-up method comprising:
setting a first range in the real space;
obtaining a position and a posture of the camera;
determining whether an object included in an image picked up by the camera is included in the first range based on the position and the posture of the camera; and
performing image processing on the image picked up by the camera, the image processing selected depending upon a result of determination in the determining.
